(19) United States
(12) Patent Application Publication
(10) Pub. No.: US 2007/0092545 A1
(43) Pub. Date: Apr. 26, 2007

(54) Aerosol coolant spray for killing and removing ticks

(76) Inventor: Isidore Bale, Oakhurst, NJ (US)

Correspondence Address: EZRA SUTTON P.A., Plaza 9 Building, 900 Route 9 North, Woodbridge, NJ, 07095, US

(21) Appl. No.: 11/258,442

(22) Filed: Oct. 25, 2005

(51) Int. Cl. A01N 65/00

(52) U.S. Cl. 424/405; 424/736; 424/745; 424/750; 424/739; 424/755; 424/747; 424/764; 424/768; 424/771; 424/776

(57) ABSTRACT

A composition of an aerosol coolant spray for killing and removing ticks from mammal skin, to be dispensed from a pressurized a pressurized aerosol spray cannister. The aerosol coolant spray composition includes a liquid coolant material for freezing the essential oil and the cooled essential oil for immobilizing and killing the tick on the skin of a mammal. The aerosol coolant spray composition further includes a diluent material being used as a carrier material for emulsifying the essential oil and the coolant material within the pressurized aerosol spray cannister.

### FIELD OF THE INVENTION

The present invention relates to an aerosol coolant spray for killing and removing ticks. More particularly, the aerosol coolant spray composition includes a coolant material, an essential oil and a diluent material.

### BACKGROUND OF THE INVENTION

Ticks are members of the superfamily Ixodoidea which are wingless, blood sucking arachnids. For the purposes of this application, the term “tick” also includes any degenerative two winged parasitic insect. These arachnids are usually parasitic on warm-blooded mammals including humans, dogs, cats, cattle, sheep or any other warm blooded mammals of the class Mammalia.

The conventional processes for tick removal from mammals present various problems. These processes include the use of tick shampoos and soaps, suffocation and heat. Tick shampoos and soaps also require relatively long exposure to harsh chemicals. Use of these products on skin involves a messy, time consuming process which includes wetting the dermis with water, applying the soap or shampoo, working the soap or shampoo into a lather and allowing it to remain in contact with the skin for an adequate amount of time, and finally thoroughly rinsing the soap or shampoo from the skin. Failure to thoroughly rinse the soap or shampoo or prolonged exposure of the skin to the soap or shampoo can cause various skin problems. Failure to allow the soap or shampoo to remain in contact with the skin for an adequate amount of time may result in the tick(s) remaining attached to the skin.

Additionally, ticks have been removed from mammals by coating the tick with grease, vaseline or nail polish to bring about suffocation of the tick. Also, ticks have been removed by touching the head of the tick with a hot match. The above methods are messy, time consuming and dangerous in the latter case. Further, the mouth parts of the tick may remain in the skin and become sites of infection.

There remains a need for an aerosol coolant spray for killing and removing ticks from mammals, such that the coolant material is used to freeze and immobilize the tick on the skin, and the essential oil is used to repel and/or kill the tick on the skin. Additionally, the aerosol coolant spray would include a diluent material being a carrier material for emulsifying the essential oil and coolant material within the spray cannister for an efficient, safe and clean method of killing and removing ticks from the skin of mammals.

### DESCRIPTION OF THE PRIOR ART

Aerosol sprays for killing, repelling and removing ticks from skin include refrigerants, anesthetic compounds or essential oil within the aerosol cannister have been generally disclosed in the prior art. For example, U.S. Pat. No. 4,834,967 to Locicero discloses a compressible liquid refrigerant in aerosol form to freeze, kill and dislodge a tick from the skin of a user.

U.S. Pat. No. 5,106,622 to Sherwood et al. discloses a repellent composition containing natural essential oils such as citronella, cedar and wintergreen to produce an environmentally safe, topical pest repellent which is effective against ticks.

U.S. Pat. No. 5,414,014 to Schneider et al. discloses an insect repellent composition having one or more anesthetic compounds for facilitating the removal of ticks from the dermis. The composition also includes a skin permeability enhancing carrier, an anti-inflammatory agent, an antibiotic and an insect repellent.

None of the prior art references teach or disclose the composition of an aerosol coolant spray for killing and removing ticks from a mammal having a coolant material, an essential oil and a diluent material in order to kill and remove ticks in a safe, quick, and efficient manner, as in the present invention.

Accordingly, it is an object of the present invention to provide a composition of an aerosol coolant spray for killing and removing ticks from the skin of mammals being dispensed from a pressurized aerosol spray cannister.

Another object of the present invention is to provide an aerosol spray composition that consists of a liquid coolant material, an essential oil and a diluent material which allows the safe, quick, painless and efficient killing and removal of ticks from the skin of mammals.

Another object of the present invention is to provide an aerosol spray composition for killing and removing ticks from mammal skin without any deleterious or harmful effect on the mammal skin of where the tick is lodged.

Another object of the present invention is to provide an aerosol spray composition for killing and removing ticks from an area of mammal skin wherein the liquid coolant material cools the essential oil which is applied to the tick so as to cool, kill and dislodge the tick from the specific area of skin that is affected.

Another object of the present invention is to provide an aerosol spray composition for killing and removing ticks from a specific area of mammal skin wherein a compressible liquid coolant material and an essential oil are in aerosol form for spraying the cooled essential oil directly on the tick so as to cool, kill and dislodge the tick from the skin of the user without freezing or damaging the skin of the user.

A further object of the present invention is to provide a pressurized aerosol coolant spray composition for killing and removing ticks from a pressurized aerosol spray cannister that can be mass produced in an automated and economical manner and is readily affordable by the consumer.

### SUMMARY OF THE PRESENT INVENTION

In accordance with the present invention, there is provided a composition of an aerosol coolant spray for killing and removing ticks from mammal skin, to be dispensed from a pressurized aerosol spray cannister. The aerosol coolant spray composition includes a liquid coolant material for freezing the essential oil and the cooled essential oil kills the tick on the skin of the mammal. The aerosol coolant spray composition further includes a diluent material being used as a carrier material for emulsifying the essential oil and the coolant material within the pressurized aerosol spray cannister.

The liquid coolant material is selected from the group consisting of chloroform, ether, fluorocarbon refrigerant R134, liquid air, liquid argon, liquid butane, liquid carbon dioxide, liquid dymel™ blend, liquid helium, liquid nitrogen, liquid oxygen, liquid propane, and other liquid refrigerant compounds, and coolant materials.

The essential oil is selected from the group consisting of cedar oil, citronella oil, wintergreen oil, pennyroyal, olive oil, eucalyptus oil, geranium oil, rosemary oil, peppermint oil, lavender oil, spearmint oil, pine needle oil, lemon oil, D-limonene, grapefruit oil, lavandin oil, cinnamon oil, clove oil, thyme oil, lemon grass oil, mandarin oil, tangerine oil, orange oil, citrus oil, lime oil, coriander oil, pomegranate oil, walnut oil, peanut oil, corn oil, canola oil, sunflower oil, sesame oil, linseed oil, safflower oil and terpenes.

The diluent material is selected from the group consisting of pectin, gum arabic, trasazapthenth, lecithin, polysorbate 20, polysorbate 60, polysorbate 80, stearic acid, glyceryl cocoate, sorbitan stearate, alginate, sunflower ceramides, guar vegetable gum, xanthen vegetable gum and other naturally occurring emulsifiers.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawings, wherein:

FIG. 1 is a perspective view of the pressurized aerosol spray cannister containing the aerosol coolant spray composition of the present invention showing the aerosol coolant spray composition in operational use being sprayed on a tick attached to the surface of the skin of a mammal; and

FIG. 2 is a top plan view of the aerosol coolant spray composition of the present invention showing the tip of a capillary-like extension tube spraying the aerosol liquid coolant spray on a tick attached to the surface of mammal skin.

### DETAILED DESCRIPTION OF THE EMBODIMENTS

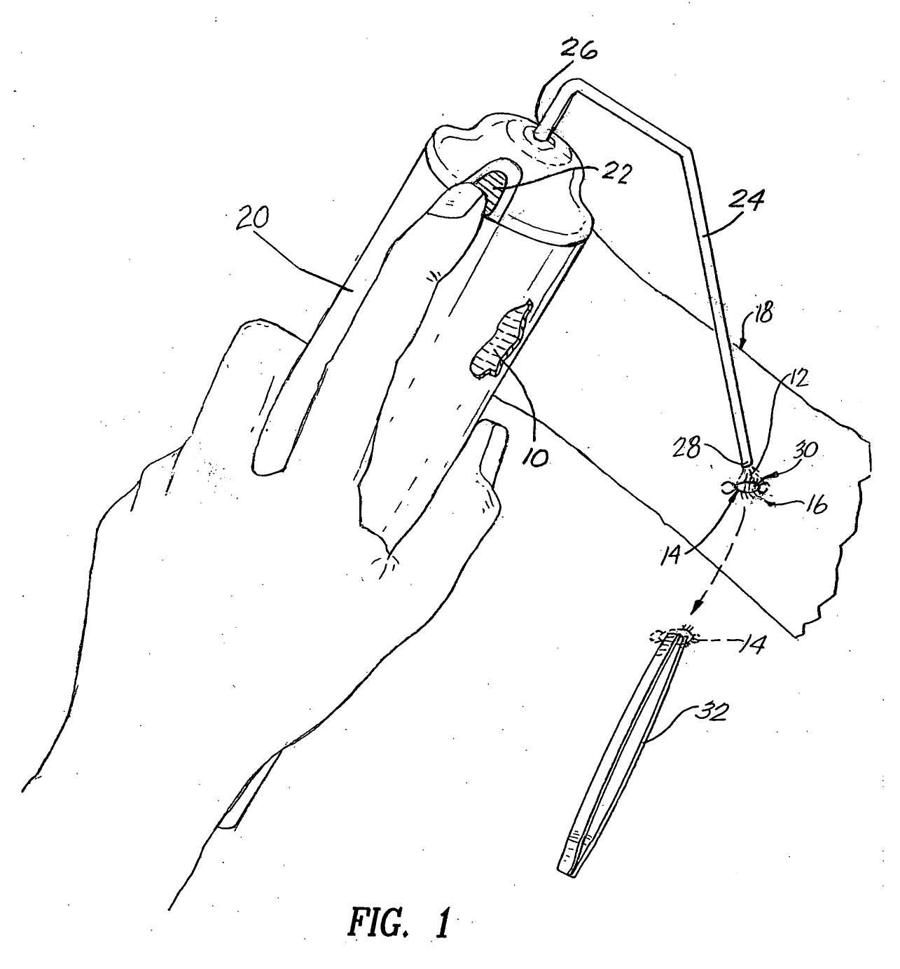

The present invention provides for a composition 10 of an aerosol liquid coolant spray 12 for killing and removing ticks 14 from the skin surface 16 of a warm-blooded, land-based mammal 18, as depicted in FIG. 1 of the drawings, wherein the tick 14 may be located on various parts of the warm blooded mammal anatomy 18 (i.e. arms, legs, feet, chest, etc). The aerosol liquid coolant spray 12 is to be dispensed from a pressurized aerosol spray cannister 20. The aerosol liquid coolant spray composition 10 includes a liquid coolant material for cooling an essential oil. The cooled essential oil is then sprayed onto the affected area of warm blooded mammal skin to immobilize and kill the tick on the mammal's skin. The aerosol coolant spray composition further includes a diluent material being used as a carrier material for emulsifying the essential oil and the coolant material within the pressurized aerosol spray cannister 20. Optionally, the aerosol liquid coolant spray composition 10 may also include a fragrance for scenting the composition 10 when applied to the skin surface 16 of the user 18.

It is understood that land-based, warm-blooded mammals include such mammals as humans, horses, pigs, sheep, cattle, goats, deer, gorillas, chimpanzees, monkeys, birds, cats, dogs and other household pets.

The liquid coolant material is selected from the group consisting of chloroform, ether, fluorocarbon refrigerant R134, liquid air, liquid argon, liquid butane, liquid carbon dioxide, liquid dymel™ blend, liquid helium, liquid nitrogen, liquid oxygen, liquid propane, and other liquid refrigerant compounds, or coolants. (See Table 1). The liquid coolant material has a boiling point in the range of −340° F. to −20° F. The liquid coolant material is in the range of 40.0% to 99.0% by weight of the total composition 10.

The essential oil is selected from the group consisting of cedar oil, citronella oil, wintergreen oil, pennyroyal, olive oil, eucalyptus oil, geranium oil, rosemary oil, peppermint oil, lavender oil, spearmint oil, pine needle oil, lemon oil, D-limonene, grapefruit oil, lavandin oil, cinnamon oil, clove oil, thyme oil, lemon grass oil, mandarin oil, tangerine oil, orange oil, citrus oil, lime oil, coriander oil, pomegranate oil, walnut oil, peanut oil, corn oil, canola oil, sunflower oil, sesame oil, linseed oil, safflower oil and terpenes. (See Table 2). Terpenes can include orange terpenes, lemon terpenes, mandarin terpenes, tangerine terpenes and lime terpenes. One or more of the essential oils maybe used within the composition 10. The essential oil 10 is in the range of 0.10% to 10.0% by weight of the total composition.

The diluent material is selected from the group consisting of but not limited exclusively to pectin, gum arabic, trasazapthenth, lecithin, polysorbate 20, polysorbate 60, polysorbate 80, stearic acid, glyceryl cocoate, sorbitan stearate, alginate, sunflower ceramides, guar vegetable gum, xanthen vegetable gum and other naturally occurring emulsifiers. (See Table 3). One or more of the diluent materials may be used within the composition 10. The diluent material is in the range of 0.50% to 30.0% by weight of the total composition.

The fragrances are selected from the group consisting of but not limited exclusively to neroli oil, anethole, rose oil, methylene, sandal wood, musk, patchouly, citronella, eucalyptus, lemon grass, lavender, kamaus, cedarwood, geranium, chamomile and spruce (See Table 4). The fragrance is in the range of 0.10 to 2.0% by weight of the total composition

TABLE 1
LIQUID COOLANT MATERIALS

chloroform
ether
fluorocarbon refrigerant R134
liquid air
liquid argon
liquid butane
liquid carbon dioxide
liquid dymel blend
liquid helium
liquid nitrogen
liquid oxygen
liquid propane
liquid refrigerant compounds and other coolant formulations

TABLE 2
NATURAL ESSENTIAL OILS

canola oil
cedar oil
cinnamon oil
citronella oil
citrus oil
clove oil
coriander oil
corn oil
D-limonene
eucalyptus oil
geranium oil
grapefruit oil
lavandin oil
lavender oil
lemon oil
lemon grass oil
lime oil
linseed oil
mandarin oil
olive oil
orange oil
pennyroyal
peppermint oil
pine needle oil
pomegranate oil
rosemary oil
spearmint oil
safflower oil
sesame oil
sunflower oil
tangerine oil
terpenes
thyme oil
walnut oil
wintergreen oil

TABLE 3
NATURAL DILUENT CARRIER MATERIALS

alginate
glyceryl cocoate
guar vegetable gum
gum arabic
lecithin
pectin
polysorbate 20
polysorbate 60
polysorbate 80
sorbitan stearate
stearic acid
sunflower ceramides
trasazapthenth
xanthen vegetable gum

TABLE 4
FRAGRANCES

anethole
cedarwood
chamomile
citronella
eucalyptus
geranium
kamaus
lavender
methylene
musk
neroli oil
patchouly
rose oil
sandal wood
spruce

| INGREDIENT | BY WEIGHT PERCENTAGES (%) |
|---|---|
| Flourocarbon refrigerant R134 | 40.0% to 99.0% |
| Cedar oil | 0.10.% to 10.0% |
| Pectin | 0.50% to 30.0% |

| INGREDIENT | BY WEIGHT PERCENTAGES (%) |
|---|---|
| Liquid nitrogen | 40.0% to 99.0% |
| Citronella oil | 0.10.% to 10.0% |
| Gum arabic | 0.50% to 30.0% |

| INGREDIENT | BY WEIGHT PERCENTAGES (%) |
|---|---|
| Liquid air | 40.0% to 99.0% |
| Wintergreen | 0.10.% to 10.0% |
| Lecithin | 0.50% to 30.0% |

| INGREDIENT | BY WEIGHT PERCENTAGES(%) |
|---|---|
| Liquid carbon dioxide | 40.0% to 99.0% |
| Pennyroyal oil | 0.10.% to 10.0% |
| Polysorbate 20 | 0.50% to 30.0% |

| INGREDIENT | BY WEIGHT PERCENTAGES (%) |
|---|---|
| Liquid nitrogen | 40.0% to 99.0% |
| Pennyroyal | 0.10.% to 10.0% |
| Guar vegetable gum | 0.50% to 10.0% |
| Rose oil | 0.50% to 2.0% |

It is understood that many different combinations of ingredients can be obtained by mixing of various liquid coolant materials, essential oils and diluent carrier materials for formulating numerous embodiments using the aforementioned listing of ingredients of liquid coolant materials, essential oils, diluent carrier materials, and the optionally added fragrances for the formation of the aerosol liquid coolant spray composition 10.

### OPERATION OF THE PRESENT INVENTION

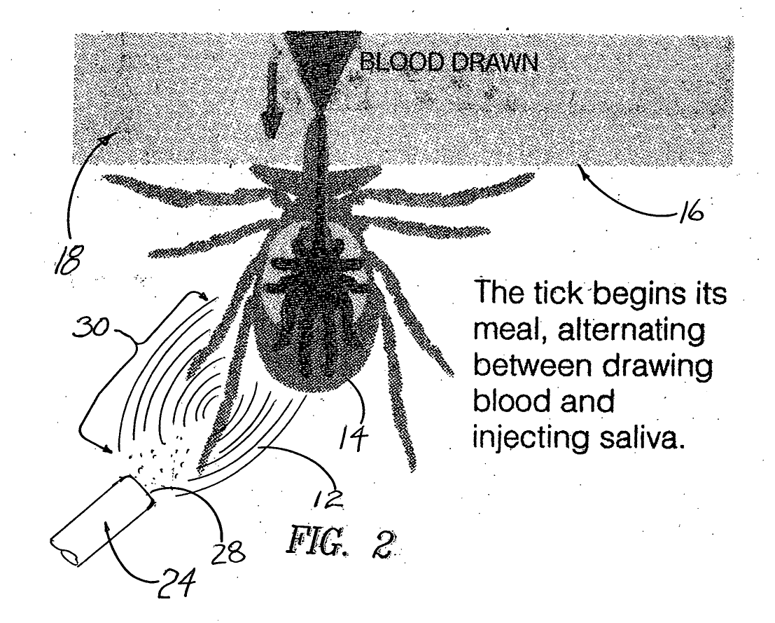

The method of operation is defined by the application of an aerosol liquid coolant spray 12 to a tick 14, in an amount sufficient to effect killing and dislodgement of the tick 14 on the skin surface 16 of the users arm 18 or other body parts. The composition 10 includes a liquid coolant material for cooling an essential oil. The cooled essential oil for immobilizing and killing the tick and a diluent/carrier material for emulsifying the coolant material and the essential oil are within a pressurized aerosol spray cannister 20, as shown in FIGS. 1 and 2 of the drawings. The coolant material is defined as a liquid that cools or freezes material by vaporization at a low temperature. The liquid coolant material includes chloroform, ether, fluorocarbon refrigerant R134, liquid air, liquid argon, liquid butane, liquid carbon dioxide, liquid dymel blend, liquid helium, liquid nitrogen, liquid oxygen, liquid propane, and liquid refrigerant compounds and other coolant formulations. (See Table 1).

More specifically, the composition 10 is an aerosol composition under pressure used to aerate the liquid coolant material and the essential oil within the small container/cannister 20. The composition 10 is dispensed through a valve 22 in the form of a spray area output 30 and can be sprayed directly on a tick 12 via a capillary-like extension tube 24 attached to the nozzle 26 of an aerosol cannister 20 of the aerosol liquid coolant spray composition 10. The composition 10 within the cannister 20 is pressurized in a range of 10 psig to 300 psig and cannister 20 can have a metered spray area output 30. The liquid composition 10 in aerosol form having a metered spray area output 30 include those marketed by Phillips ECG Inc. These canisters 20, manufactured by American Can Co., are equipped with a variable control valve 22, manufactured by Precision Valve Co., which allows a low, medium or high spray. Each discharge of the composition 10 with the valve set on low, medium or high is approximately 1 to 2 seconds in duration with the amount of refrigerant released varying between 1 to 2 milliliters in volume.

Removal of the tick 14 from the surface of the skin 16 of the mammal 18 is accomplished by placing the free end 28 of the capillary-like extension tube 24 attached to the nozzle 26 of the container 20 having the aerosol liquid coolant spray composition 10 therein, directly above the tick 14, as shown in FIG. 1. The container 20 is discharged by a user or operator as necessary to kill and dislodge the tick 14 from the surface of skin 16 on arm 18. Upon the completion of spraying, the spray area output 30 covers an affected area being a circle between 3 mm² to 6 mm², as depicted in FIG. 1. The tick 14 on skin 16 is immobilized, dead and dislodged. During discharge only the tick 14 is sprayed, so little or no over spray to the skin surface of the mammal 18 is needed. Since the composition does not directly contact the skin 16, there is no significant lowering of temperature of the skin surface 16. Final removal of the tick 14 is accomplished by picking the cooled, dead tick from the skin surface 14 on arm 18 with tweezers 32.

### ADVANTAGES OF THE PRESENT INVENTION

Accordingly, an advantage of the present invention is that it provides for a composition of an aerosol coolant spray for killing and removing ticks from the skin of mammals being dispensed from a pressurized aerosol spray cannister.

Another advantage of the present invention is that it provides for an aerosol spray composition that consists of a liquid coolant material, an essential oil and a diluent material which allows the safe, quick, painless and efficient killing and removal of ticks from the skin of mammals.

Another advantage of the present invention is that it provides for an aerosol spray composition for killing and removing ticks from mammal skin without any deleterious or harmful effect on the mammal skin where the tick is lodged.

Another advantage of the present invention is that it provides for an aerosol spray composition for killing and removing ticks from an area of mammal skin wherein the liquid coolant material cools the essential oil which is applied to the tick so as to cool, kill and dislodge the tick from the specific area of skin that is affected.

Another advantage of the present invention is that is provides for an aerosol spray composition for killing and removing ticks from a specific area of mammal skin wherein a compressible liquid coolant material and an essential oil are in aerosol form for spraying the cooled essential oil directly on the tick so as to cool, kill and dislodge the tick from the skin of the user without freezing or damaging the skin of the user.

A further advantage of the present invention is that it provides for a pressurized aerosol coolant spray composition for killing and removing ticks from a pressurized aerosol spray cannister that can be mass produced in an automated and economical manner and is readily affordable by the consumer.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A composition of an aerosol coolant spray for killing and removing ticks from the skin of a warm-blooded, land-based mammal, to be dispensed from a pressurized aerosol spray cannister, comprising:
a) an essential oil to be cooled for immobilizing and killing a tick on the skin of a mammal;
b) a liquid coolant material for cooling said essential oil in order to immobilize and kill the tick on the skin of a mammal; and
c) a diluent material being used as a carrier material for emulsifying said cooled essential oil and said coolant material within the pressurized aerosol spray container.

2. A composition in accordance with claim 1, wherein said liquid coolant material is selected from the group consisting of chloroform, ether, fluorocarbon refrigerant R134, liquid air, liquid argon, liquid butane, liquid carbon dioxide, liquid dymel™ blend, liquid helium, liquid nitrogen, liquid oxygen, liquid propane, and other liquid refrigerant compounds.

3. A composition in accordance with claim 2, wherein said liquid coolant material is in the range of 40.0% to 99.0% by weight of said composition.

4. A composition in accordance with claim 1, wherein said liquid coolant material has a boiling point in the range of −340° F. to −20° F.

5. A composition in accordance with claim 1, wherein said essential oil is selected from the group consisting of cedar oil, citronella oil, wintergreen oil, pennyroyal, olive oil, eucalyptus oil, geranium oil, rosemary oil, peppermint oil, lavender oil, spearmint oil, pine needle oil, lemon oil, D-limonene, grapefruit oil, lavandin oil, cinnamon oil, clove oil, thyme oil, lemon grass oil, mandarin oil, tangerine oil, orange oil, citrus oil, lime oil, coriander oil, pomegranate oil, walnut oil, peanut oil, corn oil, canola oil, sunflower oil, sesame oil, linseed oil, safflower oil and terpenes.

6. A composition in accordance with claim 5, wherein said terpene is selected from group consisting of orange terpenes, lemon terpenes, mandarin terpenes, tangerine terpenes and lime terpenes.

7. A composition in accordance with claim 5, wherein said essential oil is in the range of 0.10% to 10.0% by weight of said composition.

8. A composition in accordance with claim 1, wherein said diluent material is selected from the group consisting of pectin, gum arabic, trasazapthenth, lecithin, polysorbate 20, polysorbate 60, polysorbate 80, stearic acid, glyceryl cocoate, sorbitan stearate, alginate, sunflower ceramides, guar vegetable gum, xanthen vegetable gum and other naturally occurring emulsifiers.

9. A composition in accordance with claim 8, wherein said diluent material is in the range of 0.50% to 30.0% by weight of said composition.

10. A composition in accordance with claim 1, wherein said composition further includes a fragrance for scenting said composition.

11. A composition in accordance with claim 10, wherein said fragrance is selected from the group consisting of neroli oil, anethole, rose oil, methylene, sandal wood, musk, patchouly, citronella, eucalyptus, lemon grass, lavender, kamaus, cedarwood, geranium, chamomile, spruce and other naturally-occurring scents.

12. A composition in accordance with claim 10, wherein said fragrance is in the range of 0.10% to 2.0% by weight of said composition.

13. A composition in accordance with claim 1, wherein said composition is pressurized in said aerosol spray cannister in the range between 10 psig to 300 psig.

14. A method of treating a warm blooded mammal using an aerosol liquid coolant spray composition for killing and removing ticks from the skin of a mammal, to be dispensed from an aerosol spray cannister, comprising the steps of:
a) spraying a dosage of said composition on the affected area in order to freeze and kill the tick on the skin of the mammal;
b) said dosage being an effective amount for freezing and killing the tick on the skin of the mammal; and
c) removing said frozen and dead tick by picking the tick from the skin of the mammal with a suitable device.

15. A method in accordance with claim 14, wherein said step of spraying of said dosage amount being a single discharge of said aerosol spray cannister for approximately 1 to 2 seconds in duration whereby approximately 1 to 2 milliliters of said composition is released on to the affected skin area.

16. A method in accordance with claim 14, wherein said step of spraying of the affected area by said composition in an area on the skin of the mammal is in the range of 3 mm² to 6 mm².

17. A composition of an aerosol coolant spray for killing and removing ticks from mammal skin, to be dispensed from a pressurized aerosol spray cannister, comprising:
a) an essential oil to be cooled for immobilizing and killing a tick on the skin of a mammal;
b) a liquid coolant material for cooling said essential oil in order to immobilize and kill the tick on the skin of a mammal; and
c) said cooled essential oil and said coolant material are aerated together within the pressurized aerosol spray cannister.

18. A composition in accordance with claim 17, wherein said liquid coolant material is selected from the group consisting of chloroform, ether, fluorocarbon refrigerant R134, liquid air, liquid argon, liquid butane, liquid carbon dioxide, liquid dymel™ blend, liquid helium, liquid nitrogen, liquid oxygen, liquid propane, and other liquid refrigerant compounds.

19. A composition in accordance with claim 18, wherein said liquid coolant material is in the range of 40.0% to 99.0% by weight of said composition.

20. A composition in accordance with claim 17, wherein said liquid coolant material has a boiling point in the range of −340° F. to −20° F.

21. A composition in accordance with claim 17, wherein said essential oil is selected from the group consisting of cedar oil, citronella oil, wintergreen oil, pennyroyal, olive oil, eucalyptus oil, geranium oil, rosemary oil, peppermint oil, lavender oil, spearmint oil, pine needle oil, lemon oil, D-limonene, grapefruit oil, lavandin oil, cinnamon oil, clove oil, thyme oil, lemon grass oil, mandarin oil, tangerine oil, orange oil, citrus oil, lime oil, coriander oil, pomegranate oil, walnut oil, peanut oil, corn oil, canola oil, sunflower oil, sesame oil, linseed oil, safflower oil and terpenes.

22. A composition in accordance with claim 21, wherein said terpene is selected from group consisting of orange terpenes, lemon terpenes, mandarin terpenes, tangerine terpenes and lime terpenes.

23. A composition in accordance with claim 21, wherein said essential oil is in the range of 0.10% to 10.0% by weight of said composition.

24. A composition in accordance with claim 17, wherein said composition further includes a diluent material being used as a carrier material for emulsifying said cooled essential oil and said coolant material within the pressurized aerosol spray cannister.

25. A composition in accordance with claim 24, wherein said diluent material is selected from the group consisting of pectin, gum arabic, trasazapthenth, lecithin, polysorbate 20, polysorbate 60, polysorbate 80, stearic acid, glyceryl cocoate, sorbitan stearate, alginate, sunflower ceramides, guar vegetable gum, xanthen vegetable gum and other naturally occurring emulsifiers.

26. A composition in accordance with claim 24, wherein said diluent material is in the range of 0.50% to 30.0% by weight of said composition.

27. A composition in accordance with claim 17, wherein said composition further includes a fragrance for scenting said composition.

28. A composition in accordance with claim 27, wherein said fragrance is selected from the group consisting of neroli oil, anethole, rose oil, methylene, sandal wood, musk, patchouly, citronella, eucalyptus, lemon grass, lavender, kamaus, cedarwood, geranium, chamomile, spruce and other naturally-occurring scents.

29. A composition in accordance with claim 27, wherein said fragrance is in the range of 0.10% to 2.0% by weight of said composition.

30. A composition in accordance with claim 17, wherein said composition is pressurized in said aerosol spray cannister in the range between 10 psig to 300 psig.

31. A composition in accordance with claim 1, wherein said warm-blooded, land-based mammal includes a human.

32. A composition in accordance with claim 1, wherein said warm-blooded, land-based mammals are selected from the group consisting of horses, pigs, sheep, cattle, goats, deer, gorillas, chimpanzees, monkeys, birds, cats and dogs.

33. A composition in accordance with claim 17, wherein said warm-blooded, land-based mammal includes a human.

34. A composition in accordance with claim 17, wherein said warm-blooded, land-based mammals are selected from the group consisting of horses, pigs, sheep, cattle, goats, deer, gorillas, chimpanzees, monkeys, birds, cats and dogs.
